(19) United States
(12) Patent Application Publication
(10) Pub. No.: US 2015/0269958 A1
(43) Pub. Date: Sep. 24, 2015

(54) MAGNETIC RECORDING APPARATUS

(71) Applicant: KABUSHIKI KAISHA TOSHIBA, Tokyo (JP)

(72) Inventors: Masayuki TAKAGISHI, Tokyo (JP); Kenichiro YAMADA, Tokyo (JP); Tomoyuki MAEDA, Kawasaki (JP)

(21) Appl. No.: 14/659,926

(22) Filed: Mar. 17, 2015

(30) Foreign Application Priority Data
Mar. 20, 2014 (JP) 2014-059014

(51) Int. Cl. G11B 5/48; G11B 5/60

(52) U.S. Cl. CPC G11B 5/4826; G11B 5/6082

(57) ABSTRACT

A magnetic recording apparatus of an embodiment includes: a main magnetic pole, in which a width of a leading edge at an air bearing surface facing the magnetic disk is wider than a width of a trailing edge at the air bearing surface; and a magnetic head assembly, a head slider and a suspension being bonded to each other so that an angle α between a boundary line between an overlapping track and a track adjacent to the overlapping track in an opposite direction to an overlapping direction and a line obtained by extending a side of the main magnetic pole opposite to the overlapping direction at the air bearing surface is negative when a direction from the boundary line to the side is defined as a positive direction, the overlapping being performed in one direction from an inner circumference to an outer circumference of the magnetic disk.

### CROSS REFERENCE TO RELATED APPLICATIONS

This application is based upon and claims the benefit of priority from prior Japanese Patent Application No. 2014-059014 filed on Mar. 20, 2014 in Japan, the entire contents of which are incorporated herein by reference.

### FIELD

Embodiments described herein relate generally to magnetic recording apparatuses.

### BACKGROUND

In the 1990s, commercialization of magneto-resistive (MR) heads and giant magneto-resistive (GMR) heads triggered dramatic improvements in recording density and recording capacity of hard disk drives (HDDs). However, in the early 2000s, the problem of thermal fluctuations in magnetic recording media came to the surface, which temporarily slowed down the improvements in recording density. In 2005, perpendicular magnetic recording, which has more advantages in high-density recording in principle than longitudinal magnetic recording, was commercialized, and played the role of an engine for further improvements in recording density of HDDs, 40% per year, until 2010.

However, after a high recording density is achieved with the perpendicular magnetic recording, the increase in the recording density started to become sluggish again. One of the reasons therefor is the requirement in improvement in track density of magnetic recording media rapidly became too severe. The recording density is the product of “track recording density” in the circumferential direction of a recording medium and “track density” in the radial direction. The improvement in track density is greatly attributed to physical factors such as a decrease in the width of main magnetic pole of recording head and an improvement in positioning accuracy by servo systems. The track density has been rapidly improved, which has compensated for the sluggish rise in the track recording density.

The width of the main magnetic pole of a recording head should generally be narrower than the width of tracks. However, as the track density has improved to decrease the track width of magnetic recording media, which has further leaded to a rapid decrease in the width of main magnetic poles, the magnetic fields generated by the recording heads are also reduced. This has made it difficult to write data on recording media.

“Shingled magnetic recording (SMR)” is proposed to solve this problem. This method uses a recording head with a main magnetic pole that is wider than the track width to record data in a wide recording region on a track. After the data is recorded on the track, the width of the track is narrowed by further recording data on an adjacent track in an overlapping manner. This enables a normal recording operation with a recording head having a wider main magnetic pole than the track width, and solves the aforementioned problem of reduced magnetic field that occurs with the increase in track density.

The shingled magnetic recording generates a greater recording magnetic field than conventional magnetic recording (CMR) due to the use of a wider main magnetic pole. The generation of the greater magnetic field is attributed to a wider area of the surface of the main magnetic pole facing the magnetic recording medium. It is known, however, that the magnetic field is curved at the edges of main magnetic poles. This reduces the quality of the magnetic field.

As described above, the shingled magnetic recording uses one side of a wide main magnetic pole to record data. This increases a relative ratio of the portions recorded by curved magnetic field from the edges of the main magnetic pole to the entire tracks remaining after the overlapping writing. Due to this, the shingled magnetic recording cannot improve the recording density considerably.

### BRIEF DESCRIPTION OF THE DRAWINGS

FIG. 1A is a plan view of a main magnetic pole according to a first embodiment, viewed from a magnetic recording medium.

FIG. 1B is a cross-sectional view of the main magnetic pole taken along line A-A in FIG. 1A.

FIG. 1C is a cross-sectional view of the main magnetic pole taken along line B-B in FIG. 1B.

FIGS. 2A to 2C are explanatory diagrams illustrating symmetric shingled magnetic recording performed by a magnetic recording apparatus according to a comparative example.

FIG. 3 is a diagram showing the relationship between skew angle and reading error rate in symmetric shingled magnetic recording employing a magnetic head with a rectangular main magnetic pole and an inverted-trapezoid main magnetic pole.

FIG. 4 is a diagram showing the dependence of reading error rate on position in radial direction on magnetic disk in symmetric shingled magnetic recording employing a magnetic head with a rectangular main magnetic pole and a magnetic head with an inverted-trapezoid main magnetic pole.

FIG. 5A is a top view of a main magnetic pole 10 on the inner circumference of a magnetic disk 180, FIG. 5B is a top view of the main magnetic pole 10 on the outer circumference of the magnetic disk 180, and FIG. 5C is a top view of a magnetic head assembly 160.

FIG. 6 is a diagram showing the dependence of reading error rate on position in radial direction on a magnetic disk in cases where the angle α is controlled and not controlled.

FIG. 7A is a table showing respective conditions and the gain in recording density, and FIG. 7B shows the gain in recording density under the respective conditions.

FIG. 8 is a schematic diagram of a magnetic recording apparatus according to the first embodiment.

FIG. 9 is a perspective view of a head stack assembly to which a head slider is fixed.

FIGS. 10A and 10B are explanatory diagrams illustrating a main magnetic pole according to a second embodiment.

FIG. 11 is a diagram showing a characteristic of a magnetic recording apparatus according to a third embodiment.

FIGS. 12A and 12B are explanatory diagrams showing the dependence of signal-to-noise ratio on angle α.

FIGS. 13A and 13B are diagrams showing an example of how the angle α is set.

FIGS. 14A and 14B are diagrams showing another example of how the angle α is set.

### DETAILED DESCRIPTION

A magnetic recording apparatus according to an embodiment includes: a magnetic disk; a main magnetic pole, in which a width of a leading edge at an air bearing surface facing the magnetic disk is wider than a width of a trailing edge at the air bearing surface of the main magnetic pole; and a magnetic head assembly including a magnetic head on which the main magnetic pole is mounted, a head slider on which the magnetic head is mounted, a suspension to one end of which the head slider is bonded, and an actuator arm connected to the other end of the suspension, the head slider and the suspension being bonded to each other so that an angle α between a boundary line between an overlapping track and a track adjacent to the overlapping track in an opposite direction to an overlapping direction and a line obtained by extending a side of the main magnetic pole opposite to the overlapping direction at the air bearing surface is negative when a direction from the boundary line to the side is defined as a positive direction, the overlapping being performed in one direction from an inner circumference to an outer circumference of the magnetic disk.

Embodiments will now be explained with reference to the accompanying drawings.

### First Embodiment

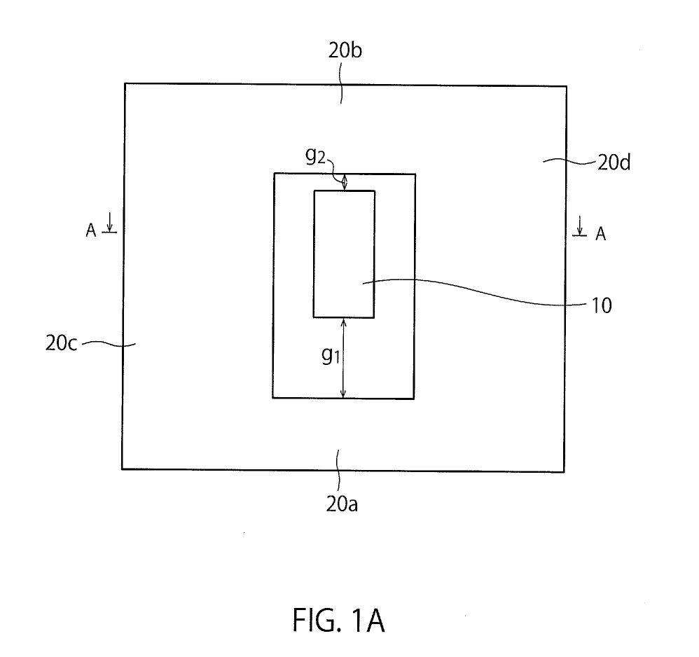

A magnetic recording apparatus according to a first embodiment will be described below. The magnetic recording apparatus according to the first embodiment includes a magnetic head with a recording unit used for shingled magnetic recording. The recording unit includes a main magnetic pole shown in FIG. 1A to FIG. 1C. FIG. 1A is a plan view of the main magnetic pole viewed from a recording medium, FIG. 1B id s cross-sectional view taken along line A-A in FIG. 1A, and FIG. 1C is a cross-sectional view taken along line B-B in FIG. 1B.

The main magnetic pole 10 according to the first embodiment is surrounded by a leading shield 20a, a trailing shield 20b, and side shields 20c, 20d at the air bearing surface (“ABS”) facing a magnetic recording medium 180. There is a leading gap g1 between the main magnetic pole 10 and the leading shield 20a, and a trailing gap g2 between the main magnetic pole 10 and the trailing shield 20b (FIG. 1A). A return yoke 30 is disposed around the main magnetic pole 10 as shown in FIG. 1C. The return yoke 30 is connected to the trailing shield 20b, and also the leading shield 20a although the connection with the leading shield 20a is not illustrated. A coil 40 surrounds the main magnetic pole 10, and is present between the main magnetic pole 10 and the return yoke 30. A current flowing through the coil 40 causes a magnetic flux to flow through the main magnetic pole 10 to write magnetization information on the magnetic recording medium 180. The direction of the magnetic flux flowing through the main magnetic pole 10 varies depending on the direction of the current flowing through the coil 40. The leading shield 20a, the trailing shield 20b, and the side shields 20c, 20d prevent the magnetic flux generated by the main magnetic pole 10 from being applied to the magnetic recording medium except for the target region.

The shape of the main magnetic pole 10 according to the first embodiment at the air bearing surface (“ABS”) facing the magnetic recording medium 180 is rectangular as shown in FIG. 1A. Thus, the width of the leading edge of the main magnetic pole at the ABS is substantially the same as the width of the trailing edge. In contrast, known main magnetic poles have an inverted-trapezoid shape at the ABS with the leading edge being wider than the trailing edge.

As described above, since the main magnetic pole 10 according to the first embodiment has a rectangular shape at the ABS, the ratio of the track width to the width of the main magnetic pole can be kept small, and the area of the surface of the main magnetic pole 10 facing the magnetic recording medium 180 can be made large.

In this manner, the magnetic field of the remaining track can be improved with the quality of magnetic field formed by the edge portion of the main magnetic pole being prevented from degrading.

The rectangular shape of the main magnetic pole, however, causes another problem, which will be described below taking an example of a magnetic head according to a comparative example used in shingled magnetic recording. The magnetic head according to the comparative example includes a main magnetic pole having an inverted trapezoid shape at the ABS.

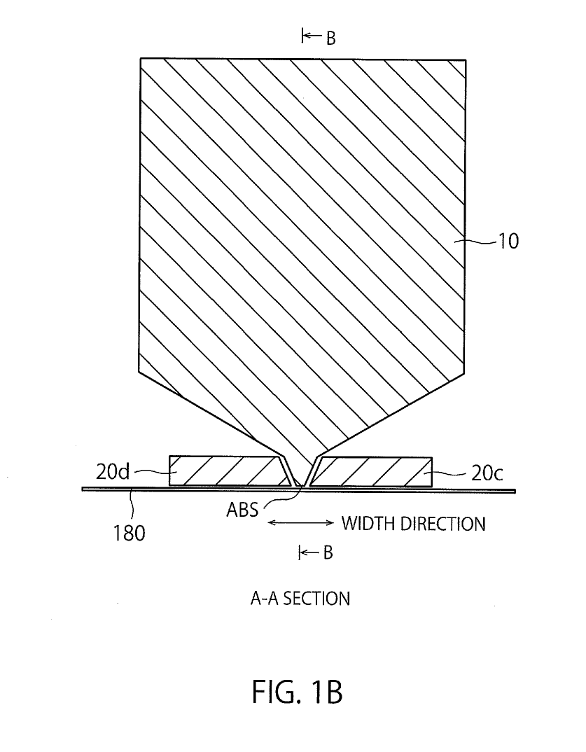

FIGS. 2A to 2C show the relationship between an angle α and a recording pattern formed on a magnetic recording medium, the angle α being between a boundary line 230 between an overlapping track and a track adjacent to the overlapping track in an opposite direction to the overlapping direction and a line obtained by extending a side 220 of the ABS of the main magnetic pole 210 on the opposite side to the overlapping direction in the comparative example.

FIG. 2A is a top view of the main magnetic pole 210 on the inner circumference of the magnetic recording medium (magnetic disk) 180, FIG. 2B is a top view of the main magnetic pole 210 on the outer circumference of the magnetic recording medium (magnetic disk) 180, and FIG. 2C is a top view of the magnetic head assembly 160. Arrows 240 in FIGS. 2A and 2B indicate overlapping directions.

The positive direction of the angle α is defined by a direction from the boundary line 230 between an overlapping track and a track adjacent to the overlapping track in an opposite direction to the overlapping direction to the line obtained by extending the side 220 of the ABS of the main magnetic pole 210 on the opposite side to the overlapping direction.

If the angle α is more than zero, a recording pattern written by the trailing edge of the main magnetic pole 210 is left on the track as shown in FIGS. 2A and 2B. An angle between the circumferential direction of the magnetic disk 180 and the center line of the magnetic head is called “skew angle.”

The skew angle generally changes from negative values to zero, and zero to positive values as the magnetic head moves from the inner circumference to the outer circumference of the magnetic disk 180 in currently available hard disk drives. In order to maintain the angle α to be more than zero, the inverted-trapezoid main magnetic pole 210 of the comparative example employs symmetric shingled magnetic recording, in which the overlapping direction is switched based on whether the skew angle is more than zero or less than zero, as shown in FIGS. 2A and 2B.

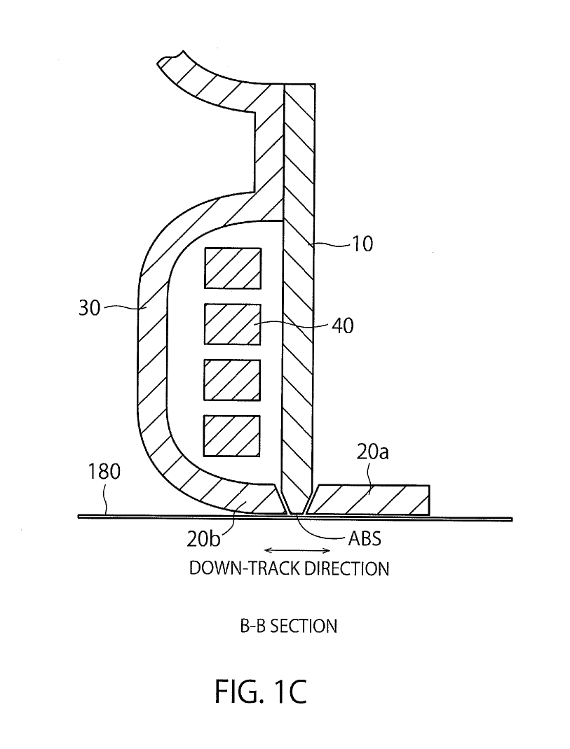

FIG. 3 shows the relationship between skew angle and reading error rate in symmetric shingled magnetic recording, for a magnetic head including a main magnetic pole having a rectangular shape at the ABS as in the first embodiment and a magnetic head including a main magnetic pole having an inverted trapezoid shape at the ABS as in the comparative example.

The recording quality of the rectangular main magnetic pole degrades rapidly after the skew angle becomes positive. The reason for this is that the angle α becomes negative after the skew angle reaches zero to leave a pattern recorded by the edge of the main magnetic pole.

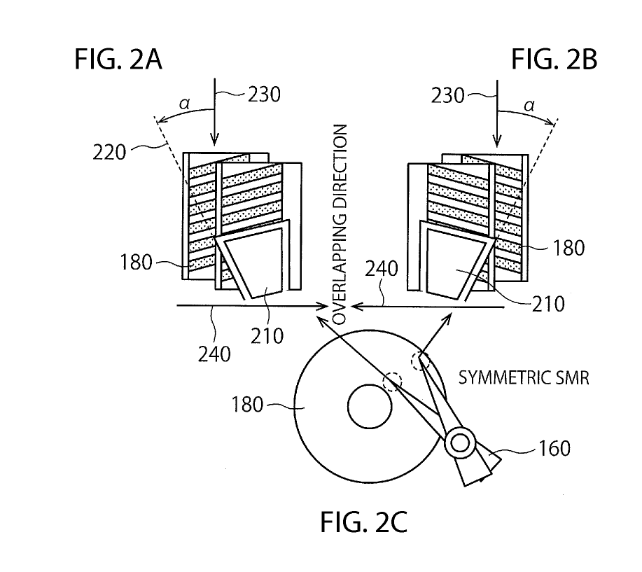

FIG. 4 shows the dependence of the reading error rate on the position in radial direction on the magnetic disk in symmetric shingled magnetic recording, for a magnetic head with a rectangular main magnetic pole and a magnetic head with an inverted-trapezoid main magnetic pole. The lateral axis in FIG. 4 indicates the position on the magnetic disk in the radial direction, which is normalized by the radius of the magnetic disk.

The point P1 in FIG. 4 indicates that the target of the angle α is +10 degrees, and the point P2 indicates that the target is 0 degree in the case of the rectangular main magnetic pole.

The point P3 indicates that the target of the angle α is +22 degrees, the point P4 indicates that the target is +12 degrees, and the point P5 indicates that the target is +22 degrees in the case of the inverted-trapezoid main magnetic pole. The point P2 and the point P4 also indicate the center of the overlapping, i.e., a position at the half of the radius of the magnetic disk.

As can be understood from FIG. 4, the reading error rate of the hard disk may be degraded since the line forming the angle α may be curved in statistical sense due to variations in the shape of the main magnetic pole and the errors in skew angle in the process of manufacturing the magnetic heads.

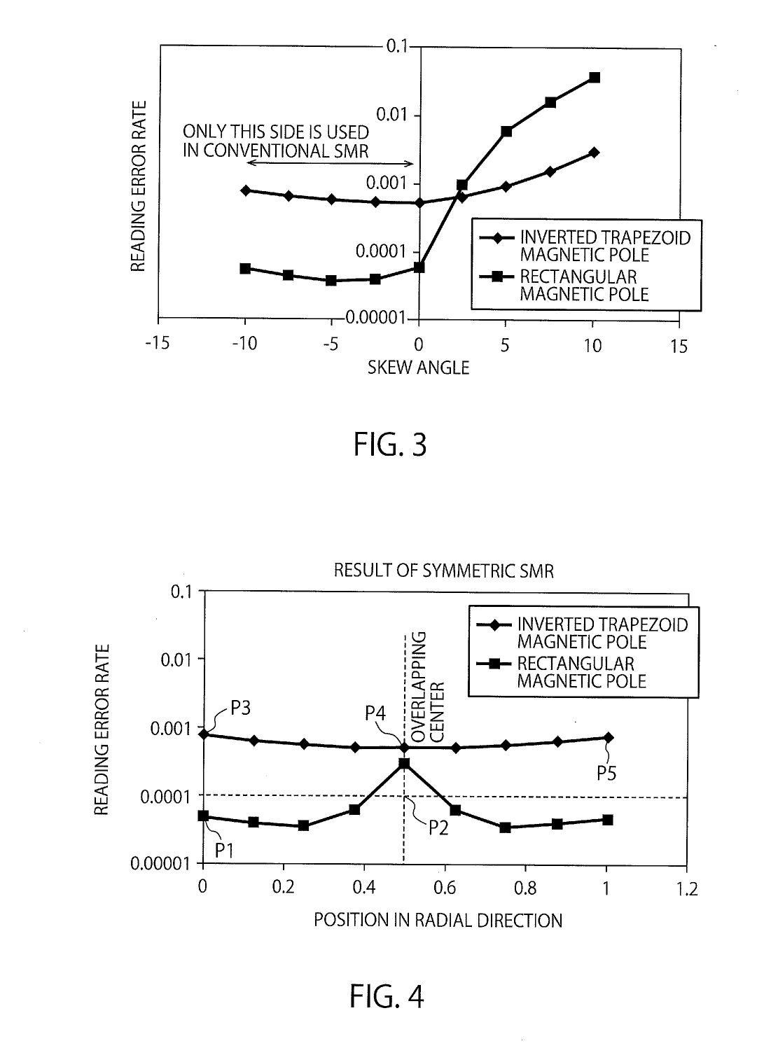

In order to use a rectangular main magnetic pole, asymmetric shingled magnetic recording, which is a kind of shingled magnetic recording, may be employed to perform overlapping only in one direction over the entire surface of the magnetic recording medium as shown in FIG. 5A to FIG. 5C so that the angle α does not become negative as the magnetic head moves from the inner circumference to the outer circumference.

The positive direction of the angle α is defined by a direction from the boundary line 230 between an overlapping track and a track adjacent to the overlapping track in an opposite direction to the overlapping direction to the line obtained by extending the side 220 of the ABS of the main magnetic pole 210 on the opposite side to the overlapping direction.

The magnetic recording apparatus according to the first embodiment employs the asymmetric shingled magnetic recording.

FIG. 5A is a top view of the main magnetic pole 10 on the inner circumference of a magnetic disk 180, FIG. 5B is a top view of the main magnetic pole 10 on the outer circumference of the magnetic disk 180, and FIG. 5C is a top view of a magnetic head assembly 160. Arrows 240 in FIGS. 5A and 5B indicate the overlapping direction. As can be understood from FIGS. 5A and 5B, the angle α is zero when the magnetic pole 10 is on the inner circumference, and is a positive value when the magnetic pole 10 is on the outer circumference. This means that the angle α is not negative.

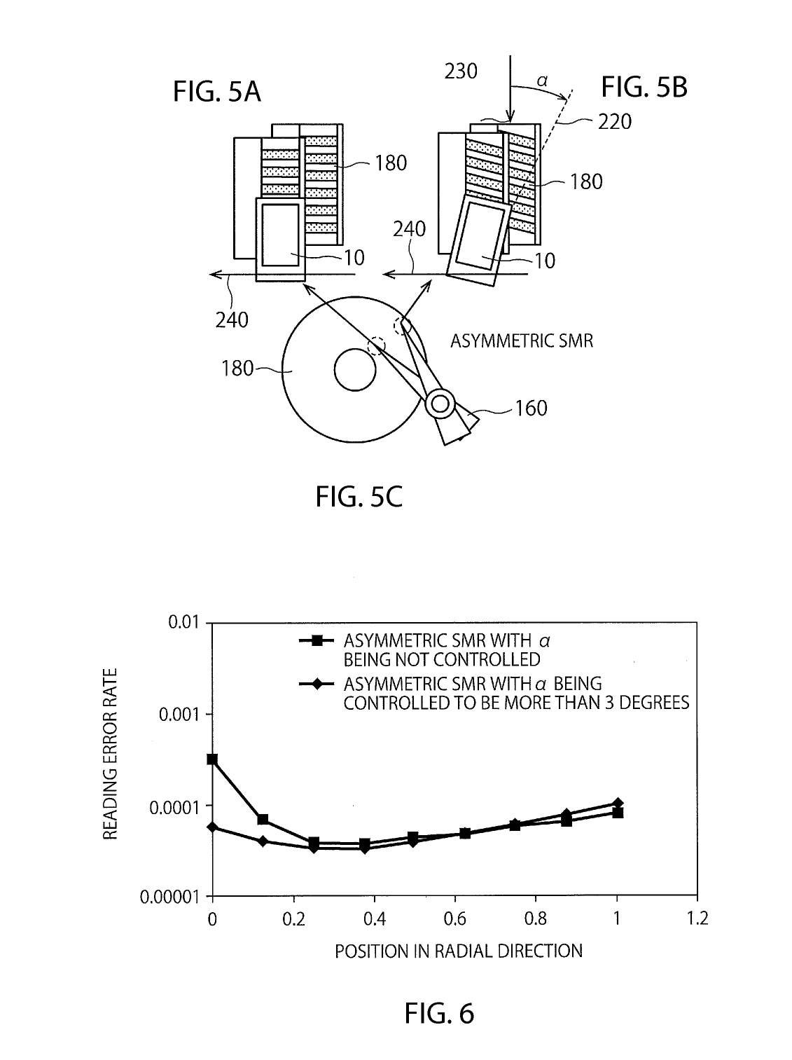

The first embodiment further controls the angle α to have positive values even if errors and variations in manufacturing occur. As a result, the degradation in the reading error rate in a region where the skew angle is close to zero can be suppressed as shown in FIG. 6.

FIG. 6 shows the dependence of reading error rate on the position in radial direction in asymmetric shingled magnetic recording for a magnetic head with a rectangular main magnetic pole in a case where the angle α is maintained to be more than 3 degrees, and a case where the angle α is not controlled.

As can be understood from FIG. 6, the degradation in the reading error rate in a region where the position in radial direction is close to zero, i.e., a region where the skew angle is close to zero, can be more suppressed in the case where the angle α is maintained to be 3 degrees or more. The angle α is preferably 10 degrees or less.

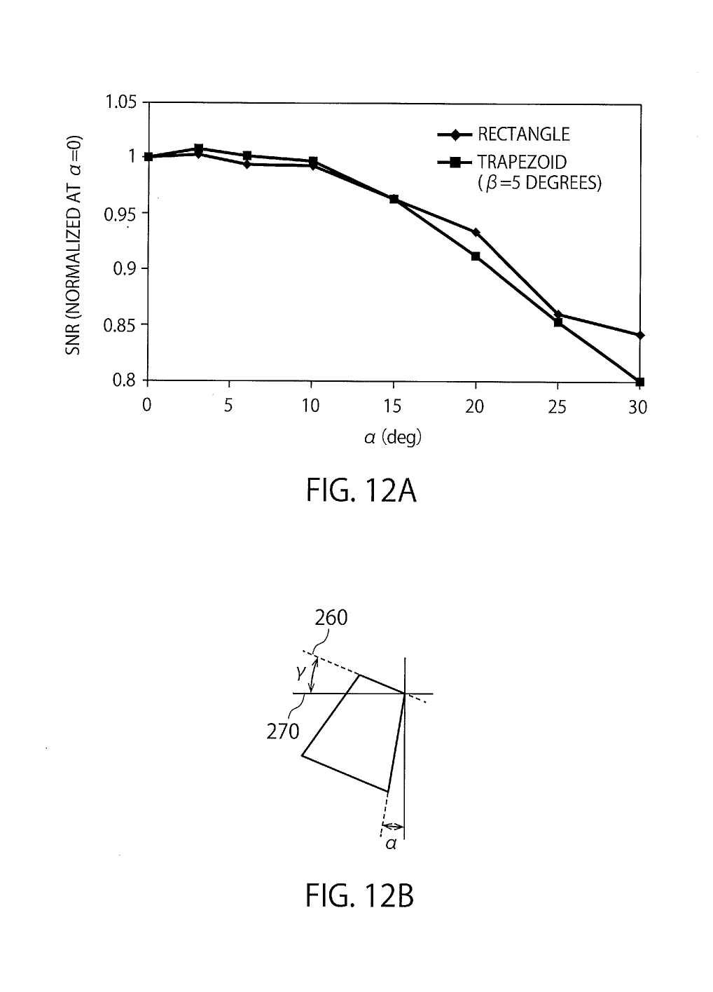

The reason for this is as follows. Regardless of whether the shape at the ABS of the main magnetic pole is rectangle or trapezoid, as the angle α increases, the magnetization transition region (for example, the region indicated by a broken line 260 in FIG. 12B) to be recorded is shifted from a line 270 that crosses the tracks of the magnetic recording medium at an angle of 90 degrees. This makes the angle γ greater. The error rate reaches the greatest value when the magnetization transition region 260 crosses the tracks at an angle of 90 degrees.

According to the simulation result shown in FIG. 12A, however, the signal-to-noise ratio is not affected by the angle α if it is less than 10 degrees. Specifically, the signal-to-noise ratio and the error rate do not change greatly if the angle α is less than 10 degrees. Therefore, the angle α is preferably 10 less than. The angle α is set by a method to be described later.

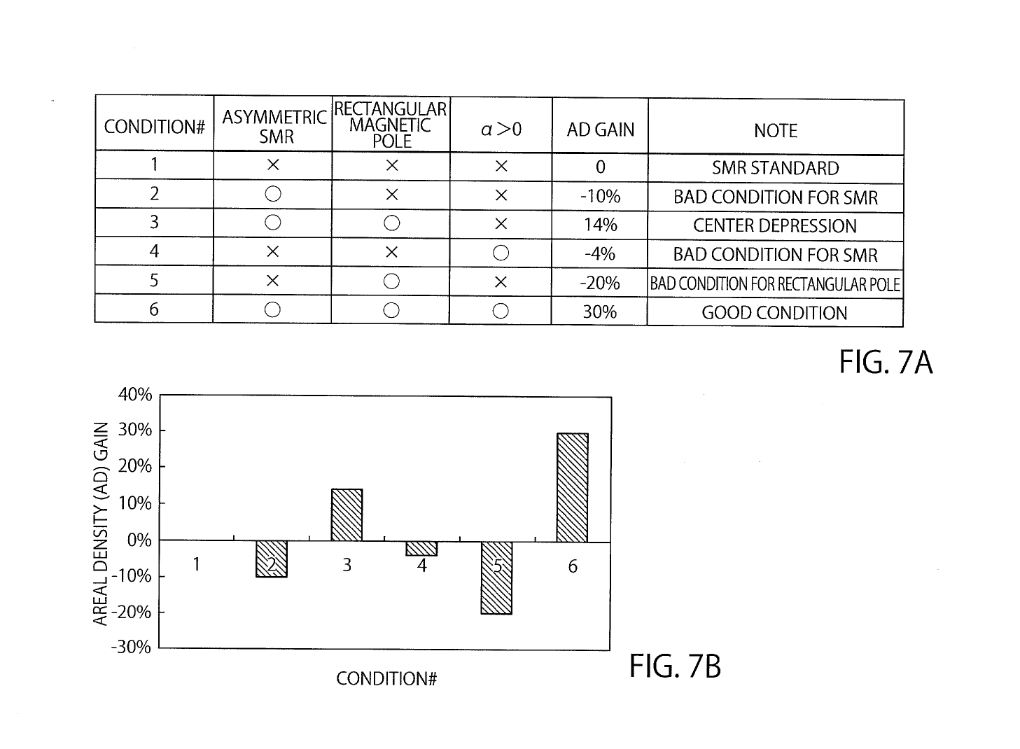

FIGS. 7A and 7B show a result of measuring recording density gain (the ratio of improvement in recording density to the value under Standard Condition (Condition#1)) under various conditions. FIG. 7A is a diagram showing the various conditions and the recording density gains (areal density gains), and FIG. 7B is a diagram showing the recording density gains under the various conditions.

As can be understood from FIGS. 7A and 7B, a remarkable recording density gain can be obtained by the first embodiment employing a rectangular main magnetic pole, asymmetric shingled magnetic recording, and an angle α that is maintained to be positive relative to the recording density gains obtained by an inverted trapezoid main magnetic pole and/or by conventional symmetric shingled magnetic recording.

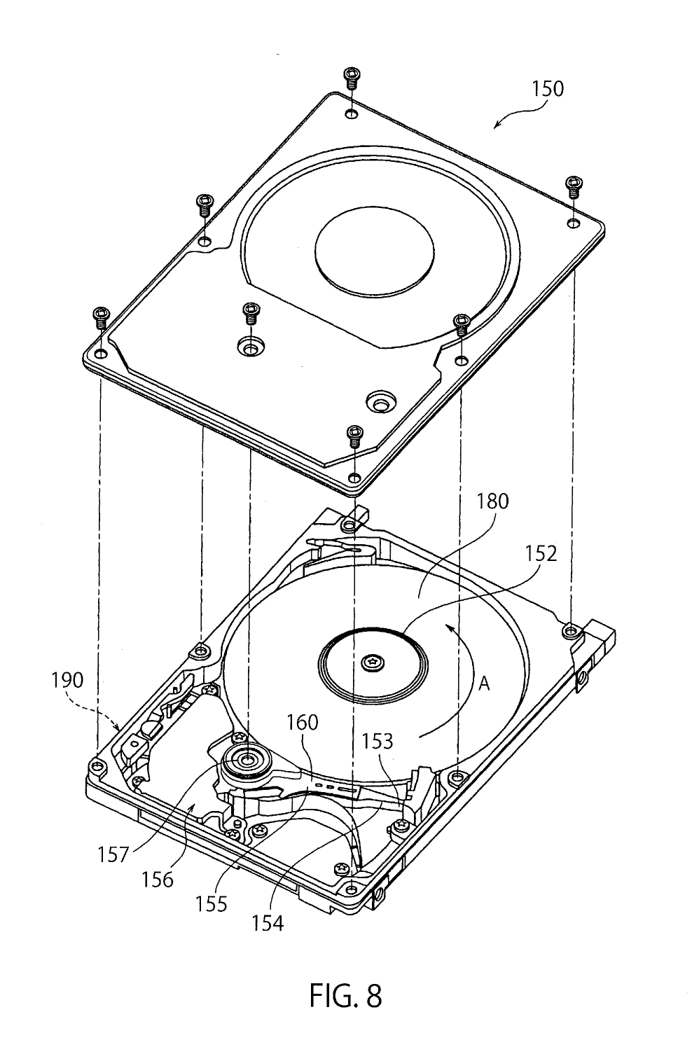

FIG. 8 shows an example of magnetic recording apparatus according to the first embodiment.

The magnetic head according to the first embodiment described above can be included in a recording and reproducing magnetic head assembly, for example, and mounted on a magnetic recording and reproducing apparatus. The magnetic recording apparatus according to the first embodiment may have only a recording function or both a recording function and a reproducing function. If it has both the functions, the magnetic recording apparatus serves as a magnetic recording and reproducing apparatus. In the following descriptions, the magnetic recording apparatus according to the first embodiment is a magnetic recording and reproducing apparatus.

FIG. 8 is a schematic perspective view of a magnetic recording and reproducing apparatus according to the first embodiment. As shown in FIG. 8, the magnetic recording and reproducing apparatus 150 according to the first embodiment including a rotary actuator. In FIG. 8, a magnetic disk 180 is set to a spindle motor 152, and rotated in the direction of an arrow A by a motor (not shown) that responds to a control signal from a drive device controller (not shown). The magnetic recording and reproducing apparatus 150 according to the first embodiment may include a plurality of magnetic disks 180.

A head slider 153 for recording and reproducing data stored in the magnetic disk 180 is attached to a tip of a suspension 154 in a thin film form. The head slider 153 has, at around the tip thereof, the magnetic head according to the first embodiment together with a magnetic shield.

When the magnetic disk 180 is rotated, the air bearing surface (ABS) of the head slider 153 is lifted and held above the surface of the magnetic disk 180 at a certain floating distance. The head slider 153 may be of so-called “contact tracking type” that contacts the magnetic disk 180.

The suspension 154 is connected to an end of an actuator arm 155 including such parts as a bobbin portion for supporting a drive coil (not shown). The other end of the actuator arm 155 is connected to a voice coil motor 156, which is a kind of linear motor. The voice coil motor 156 may include the drive coil (not shown) wound around the bobbin portion of the actuator arm 155, and a magnetic circuit including a permanent magnet and a facing yoke that are arranged at both the sides of the coil to face each other.

The actuator arm 155 is supported by ball bearings (not shown) arranged at upper and lower portions of a bearing unit 157, and can be rotated and slid freely by means of the voice coil motor 156.

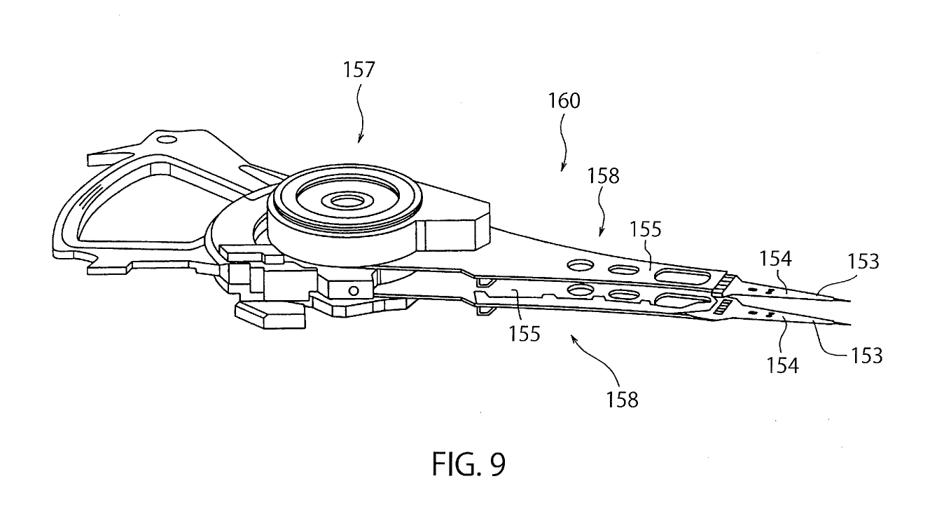

FIG. 9 shows an example of the structure of a part of the magnetic recording and reproducing apparatus according to the first embodiment, and is an enlarged perspective view of a magnetic head assembly 160 from the actuator arm 155 to the end, viewed from the disk side.

As shown in FIG. 9, the magnetic head assembly 160 includes the bearing unit 157, a head gimbal assembly (“HGA”) 158 extending from the bearing unit 157, and a support frame that supports the coil of the voice coil motor and extends from the bearing unit 157 to a direction opposite to the direction of the HGA. The HGA includes the actuator arm 155 extending from the bearing unit 157, and the suspension 154 extending from the actuator arm 155.

The head slider 153 including the magnetic head according to the first embodiment is attached to the tip of the suspension 154.

Thus, the magnetic head assembly 160 according to the first embodiment includes the magnetic head according to the first embodiment, the suspension 154 for holding the magnetic head at one end thereof, and the actuator arm 155 attached to the other end of the suspension 154.

The suspension 154 includes a lead line (not shown) for writing and reading signals, which is electrically connected to respective electrodes of the magnetic head attached to the head slider 153. The magnetic head assembly 160 also includes an electrode pad that is not shown.

The magnetic head assembly 160 further includes a signal processing unit 190 (not shown) for writing signals to and reading signals from the magnetic disk 180 using the magnetic head. The signal processing unit 190 is, for example, attached to the back side of the magnetic recording and reproducing apparatus 150 shown in FIG. 8. Input and output lines of the signal processing unit 190 are connected to the electrode pad, and electrically coupled to the magnetic recording head.

Thus, the magnetic recording and reproducing apparatus 150 according to the first embodiment includes the magnetic disk 180, the magnetic head according to the first embodiment, a movable unit (movement controller) for keeping the positions of the magnetic disk and the magnetic head to face each other in a separating or contacting state, and causing them to move relative to each other, a position controller for adjusting the position of the magnetic head to a predetermined recording position on the magnetic disk, and a signal processing unit for writing signals to and reading signals from the magnetic disk by means of the magnetic head. The movable unit may include the head slider 153. The position controller may include the magnetic head assembly 160.

When the magnetic disk 180 is rotated, and the voice coil motor 156 is caused to rotate the actuator arm 155 to load the head slider 153 above the magnetic disk 180, the air bearing surface (ABS) of the head slider 153 attached to the magnetic head is supported above the surface of the magnetic disk 180 at a predetermined distance therefrom. The data stored in the magnetic disk 180 can be read based on the aforementioned principle.

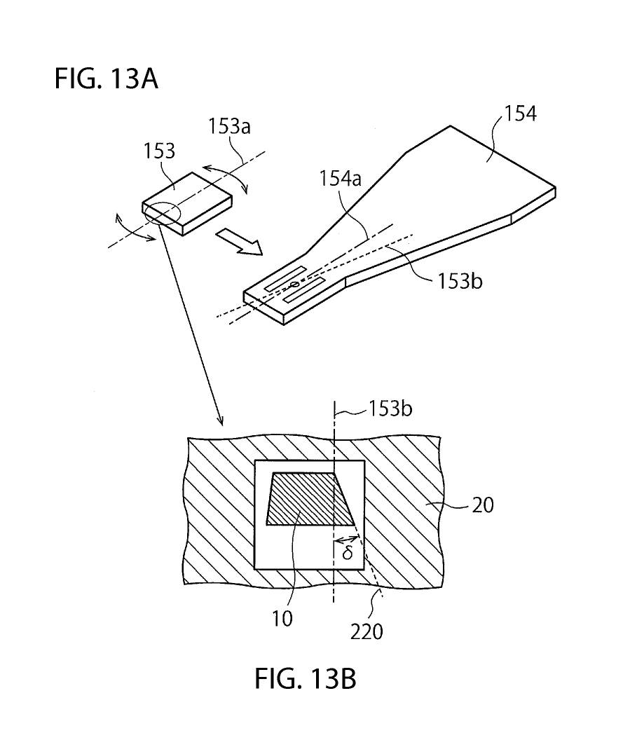

A first method of setting the angle α will be described below with reference to FIGS. 13A and 13B. FIG. 13A is a perspective view of the head slider 153 and the suspension 154 for explaining an example of method of setting the angle α, and FIG. 13B is a plan view of the main magnetic pole 10 viewed from the magnetic disk 180. FIG. 13B shows a main magnetic pole according to a second embodiment, which will be described later, as the main magnetic pole 10, but the main magnetic pole according to the first embodiment can also be used. The head slider 153 is attached and bonded onto the suspension 154. The angle α is set at the bonding. Before the bonding, the shape of the main magnetic pole 10 is confirmed using an atomic force microscope (AFM) or magnetic force microscope (MFM). At this time, an angle δ between a line 153b that is parallel to a central line 153a of the head slider 153 and a side 220 of the main magnetic pole 10 is measured as shown in FIG. 13A and FIG. 13B. The angle α is calculated from the relationship between the angle δ and the skew angle of the magnetic disk 180, and the head slider 153 is bonded to the suspension 154 so that the angle α is negative. The reference numeral 20 in FIG. 13B denotes shield.

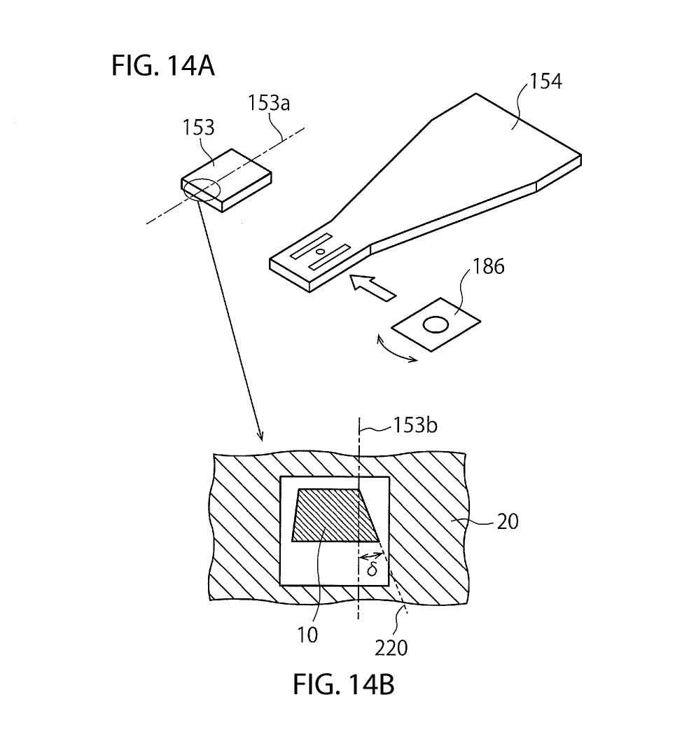

A second method of setting the angle α will be described below with reference to FIGS. 14A and 14B. FIG. 14A is a perspective view of the head slider 153 and the suspension 154 for explaining another example of method of setting the angle α. FIG. 14B is a plan view of the main magnetic pole 10 viewed from the magnetic disk 180. FIG. 14B shows the main magnetic pole of the second embodiment, which will be described later, as the main magnetic pole 10, but the main magnetic pole according to the first embodiment can also be used. Before bonding the head slider 153 onto the suspension 154, the shape of the main magnetic pole 10 is confirmed using an atomic force microscope (AFM) or magnetic force microscope (MFM). At this time, an angle δ between a line 153b that is parallel to the central line 153a of the head slider 153 and a side 220 of the main magnetic pole 10 is measured as shown in FIG. 14A and FIG. 14B. Thereafter, a rotary actuator 186 is mounted and bonded onto a region of the suspension 154 where the head slider 153 is to be bonded. The head slider 153 is then mounted and bonded onto the rotary actuator 186. The angle α is calculated from the relationship between the measured angle δ and the skew angle of the magnetic disk 180, and the rotations of the rotary actuator 186 is controlled so that the angle α is negative. For example, the rotations of the rotary actuator 186 are electrically controlled by a signal processing unit 190 shown in FIG. 8. The rotational operation of the rotary actuator 186, which is controlled to make the angle α negative, is fixed by the signal processing unit 190. The reference numeral 20 in FIG. 14B denotes shield.

As described above, according to the first embodiment, a magnetic recording apparatus that achieves a high recording density by shingled magnetic recording can be provided.

### Second Embodiment

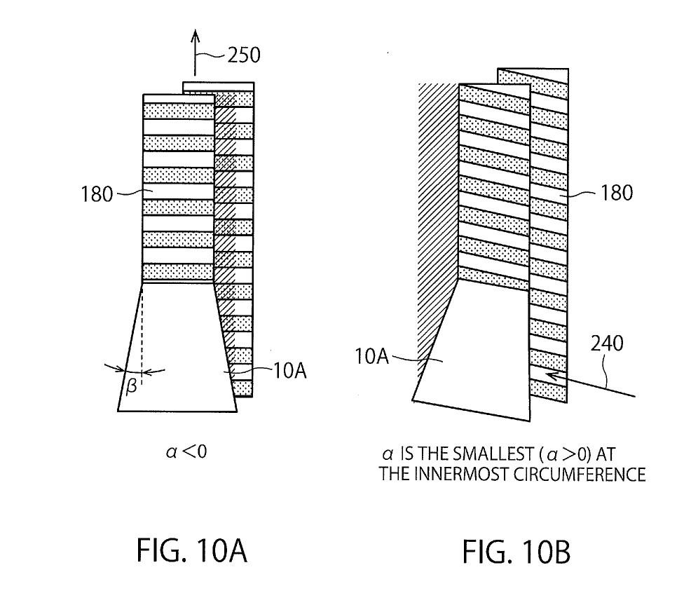

A magnetic recording apparatus according to a second embodiment will be described with reference to FIGS. 10A and 10B. The magnetic recording apparatus according to the second embodiment has a main magnetic pole in a trapezoid shape at the ABS as shown in FIGS. 10A and 10B. The other portions are the same as those in the magnetic recording apparatus according to the first embodiment.

Thus, the width of the trailing edge is narrower than the width of the leading edge at the ABS of the main magnetic pole 10A according to the second embodiment.

The arrow 250 in FIG. 10A indicates the direction along which the magnetic disk 180 moves (rotation direction), and the arrow 240 in FIG. 10B indicates the overlapping direction.

The trapezoid shape at the ABS of the main magnetic pole, in which the width of the leading edge is wider than the trailing edge as in the second embodiment, makes the area at the ABS of the main magnetic pole greater than the area thereof in the first embodiment. If the bevel angle β shown in FIG. 10A is increased from 0 degree to 10 degrees in a magnetic recording apparatus with the recording density of about 1 tera bit per 1 square inch (500 kT/inch×2100 kB/inch), the effective magnetic field can be increased by 6%. This makes the gain of about 5% in recording density, which is calculated by a simulation.

If a rectangular main magnetic pole as in the first embodiment, however, is used, and the skew angle of the magnetic head on the inner circumference is set to be about 0, the angle α becomes a negative value as can be understood from FIG. 10A. This forms a region in the outer direction with low writing quality, and further leads to a decrease in error rate.

If a trapezoid main magnetic pole is used, the angle α becomes the lowest when the magnetic head is on the inner circumference as shown in FIG. 10B. It is preferable that the angle α is greater than 0 at all the positions in the radial direction. The skew angle of the magnetic head on the inner circumference becomes more than 10 degrees, and increases toward the outer circumference in this case. On the outermost circumference, the skew angle becomes about 30 degrees.

Thus, there is a defect in that the skew angle becomes too large on the outer circumference, which may lead to a decrease in reading error rate. In view of this, the bevel angle β of the trapezoid main magnetic pole is preferably 10 degree or less. The bevel angle is defined as an angle between one of the legs of the main magnetic pole, which is a side of the main magnetic pole different from the leading edge or trailing edge at the ABS, and a perpendicular line from an end of the trailing edge to the leading edge.

The magnetic recording apparatus according to the second embodiment can achieve a higher recording density than that achieved in the first embodiment.

### Third Embodiment

A magnetic recording apparatus according to a third embodiment will be described below.

It is assumed that the overlapping in shingled magnetic recording is performed asymmetrically from the outer circumference to the inner circumference. If the skew angle at the inner circumference of a commonly-used 2.5-inch hard disk is 3 degrees, the skew angle at the outer circumference exceeds 20 degrees. Even if the angle α is maintained to be positive, the performance would be degraded if the absolute value of the skew angle is increased. Accordingly, especially when asymmetric recording is employed, suppression in variations of skew angle would make a good result. This can be achieved by, for example, having a long head arm portion.

The variations in skew angle can be suppressed to be within 2-degree range at maximum by having a long arm portion in a currently-used 2.5-inch hard disk with the aforementioned technique.

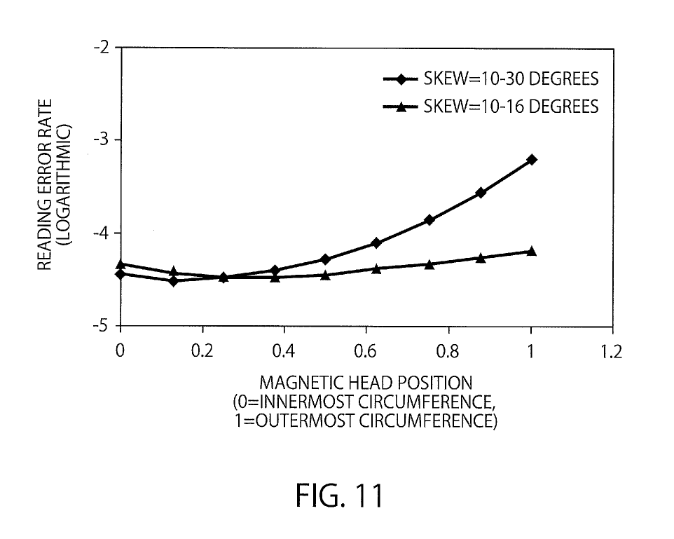

FIG. 11 shows a result of the comparison between the reading error rate in a case where the skew angle is not controlled and therefore correspond to that in commonly-used 2.5-inch hard disk and the reading error rate in a case where the variations in skew angle are kept within 5-degree range using a long arm, the comparison performed using a magnetic head including a main magnetic pole in a trapezoid shape, in which the bevel angle β is 10 degrees.

As can be understood from FIG. 11, the error rate at the outermost circumference is worse than that of the innermost circumference on the order of 1.5 digits in a general skew angle design. However, the degradation in error rate at the outermost circumference can be substantially prevented by employing a long arm.

The magnetic recording apparatus according to the third embodiment is obtained by adding a mechanism for suppressing variations in skew angle to the magnetic recording apparatus according to the second embodiment.

As in the case of the second embodiment, a magnetic recording apparatus according to the third embodiment can achieve a higher recording density.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A magnetic recording apparatus comprising:
a magnetic disk;
a main magnetic pole, in which a width of a leading edge at an air bearing surface facing the magnetic disk is wider than a width of a trailing edge at the air bearing surface of the main magnetic pole; and
a magnetic head assembly including a magnetic head on which the main magnetic pole is mounted, a head slider on which the magnetic head is mounted, a suspension to one end of which the head slider is bonded, and an actuator arm connected to the other end of the suspension, the head slider and the suspension being bonded to each other so that an angle α between a boundary line between an overlapping track and a track adjacent to the overlapping track in an opposite direction to an overlapping direction and a line obtained by extending a side of the main magnetic pole opposite to the overlapping direction at the air bearing surface is negative when a direction from the boundary line to the side is defined as a positive direction,
the overlapping being performed in one direction from an inner circumference to an outer circumference of the magnetic disk.

2. The apparatus according to claim 1, wherein an angle formed by a leg of the main magnetic pole, which is one of sides, which his different from the leading edge and the trailing edge, at the air bearing surface and a perpendicular line from an end of the trailing edge to the leading edge is 10 degrees or less.

3. The apparatus according to claim 1, wherein the main magnetic pole is substantially in a trapezoid shape at the air bearing surface.

4. The apparatus according to claim 1, wherein the angle α is 3 degrees or more from the inner circumference to the outer circumference of the magnetic disk.

5. The apparatus according to claim 1, further comprising a rotary actuator disposed between the head slider and the suspension.

6. The apparatus according to claim 1, further comprising a reproduction unit that reads data from the magnetic disk.

7. A magnetic recording apparatus comprising:
a magnetic disk;
a main magnetic pole including an air bearing surface facing the magnetic disk, in which a width of a leading edge at the air bearing surface is substantially identical with a width of trailing edge at the air bearing surface of the main magnetic pole; and
a magnetic head assembly including a magnetic head on which the main magnetic pole is mounted, a head slider on which the magnetic head is mounted, a suspension to one end of which the head slider is bonded, and an actuator arm connected to the other end of the suspension, the head slider and the suspension being bonded to each other so that an angle α between a boundary line between an overlapping track and a track adjacent to the overlapping track in an opposite direction to an overlapping direction and a line obtained by extending a side of the main magnetic pole opposite to the overlapping direction at the air bearing surface is negative when a direction from the boundary line to the side is defined as a positive direction,
the overlapping being performed from an inner circumference to an outer circumference of the magnetic disk.

8. The apparatus according to claim 7, wherein the angle α is 3 degrees or more from the inner circumference to the outer circumference of the magnetic disk.

9. The apparatus according to claim 7, wherein the main magnetic pole is substantially in a rectangular shape at the air bearing surface.

10. The apparatus according to claim 7, further comprising a rotary actuator disposed between the head slider and the suspension.

11. The apparatus according to claim 7, further comprising a reproduction unit that reads data from the magnetic disk.
